(19) United States
(12) Patent Application Publication
(10) Pub. No.: US 2026/0197300 A1
(43) Pub. Date: Jul. 9, 2026

(54) METHOD FOR COMMUNICATION BETWEEN A FIRST DEVICE AND A REMOTE SERVER, CORRESPONDING METHOD FOR MANAGING COMMUNICATIONS, FIRST DEVICE, REMOTE SERVER AND COMPUTER PROGRAM

(71) Applicant: ORANGE, Issy-les-Moulineaux (FR)

(72) Inventors: Mohamed Boucadair, Châtillon (FR); Christian Jacquenet, Châtillon (FR)

(21) Appl. No.: 18/874,297

(22) PCT Filed: Jun. 15, 2023
(86) PCT No.: PCT/EP2023/066058

§ 371 Date: Dec. 12, 2024

(30) Foreign Application Priority Data
Jun. 16, 2022 (FR) FR2205883

(51) Int. Cl. H04L 9/40; H04L 61/5053; H04L 67/141; H04L 101/622

(52) U.S. Cl. CPC H04L 63/0428; H04L 61/5053; H04L 67/141; H04L 2101/622

(57) ABSTRACT

A method for managing communications of a first device, implemented by a remote server. The method includes: establishing a first secure connection between the first device and the remote server, via a first communication interface of the first device; and transmitting, using the first secure connection, an instruction for managing at least one current MAC address associated with at least one second communication interface of the first device.

### 1. FIELD OF THE INVENTION

The field of the invention is that of communications within at least one communication network, for example a computer network implementing the IP protocol.

More specifically, the invention relates to the management of at least one MAC (Media Access Control) address assigned to at least one interface of a device connected to a communication network.

In particular, the invention proposes a solution contributing to preserving the confidentiality of communications.

### 2. PRIOR ART

The QUIC protocol is a communication protocol based on the UDP (User Datagram Protocol) protocol of the transport layer. Compared with the TCP (Transmission Control Protocol) protocol, the QUIC protocol notably reduces latency times generally observed when establishing TCP connections.

Unlike the TLS (Transport Layer Security) protocol, the QUIC protocol not only encrypts payload, but also connection control information. Thus, conventional solutions for inserting application proxies cannot be directly reused for communications established using the QUIC protocol. QUIC connection control information sent in clear text is kept to a strict minimum. For example, a QUIC packet comprises an unencrypted header with one or more flags, one or more connection identifiers and a packet number.

In order to support a change of IP address of a device, such as a terminal, without having to terminate a current QUIC connection, the QUIC protocol does not rely on transport identifiers, a transport identifier (also sometimes referred to as a “transport address”) being defined by a quadruplet {source IP address, source port number, destination IP address, destination port number}, but on at least one connection identifier, referred to as CID (for “Connection Identifier”) or CONNECTION_ID.

The QUIC specification defines two types of CID: Destination CID and Source CID.

The QUIC protocol supports a connection migration mechanism that maintains a QUIC connection active in case of change of one of the addresses (or port numbers) of the devices involved in establishing and maintaining the QUIC connection (including address changes performed by NATs (Network Address Translation) placed on a path taken by the data exchanged as part of a QUIC connection). Thus, a connection migration consists in switching from one transport identifier defined by a quadruplet {source address, source port, destination address, destination port} to another. In the following, and by way of example, a communication path is identified by a transport identifier defined by a quadruplet {source address, source port, destination address, destination port}. Modifying at least one parameter in this quadruplet results in a new communication path. It should be noted however that this definition does not require the corresponding “physical” paths to be totally or partially disjointed (in other words, modifying said at least one parameter does not mean that the physical paths, that is the routes taken by the data, differ). The devices involved in establishing and maintaining the QUIC connection can validate a new address used, for example, by the QUIC device that initiated the establishment of the connection using the PATH_CHALLENGE and PATH_RESPONSE frames exchanged between these devices to validate a connection migration. The same connection migration procedure is set up in case the remote device announces a new address.

Although this solution maintains a QUIC connection in case the communication path changes (that is, in case of change of one of the addresses or port numbers of the quadruplet {source IP address, source port number, destination IP address, destination port number}), it has the disadvantage of making it possible to trace the communications of a user of a device with which the QUIC connection has been established. This may adversely affect the confidentiality of the data exchanged by users of such devices, or of data characteristic of these users.

A first solution to try and limit the tracing of communications in case of connection migration is based on the use of new connection identifiers for communications established on other paths, within the same QUIC connection.

However, such a solution is not sufficient to provide strict guarantees that QUIC connections cannot be traced, particularly when the same MAC address is used by a device such as a terminal for communications established on different paths.

It is recalled in this respect that MAC addresses are identifiers assigned to network interfaces for communication purposes. These identifiers are generally assigned by the manufacturers of the network adapters. A MAC address is often considered to be unique and permanent (that is it does not change over time), making it possible to track and identify a device such as a terminal, even when it is in motion.

There is therefore a need for a new solution improving the confidentiality of communications.

### 3. SUMMARY OF THE INVENTION

The invention proposes a solution in the form of a method for managing communications of a first device, implemented by a remote server, comprising:
establishing a first secure connection between said first device and said remote server, via a first communication interface of said first device,
transmitting, using said first secure connection, an instruction for managing at least one current MAC address associated with at least one second communication interface of the first device.

It should be noted that the first and second communication interfaces of the first device can be the same interface or separate interfaces. For example, the first device is a terminal (fixed or mobile, such as a computer, a smartphone, etc.) comprising one or more communication interfaces, for example a WLAN (Wireless LAN) interface, an Ethernet interface, etc.

The first device and the remote server can be connected to the same network, for example an access network, or to separate networks. For example, the first device is connected to a local area network, such as a home network or a company intranet. Such a network can possibly be a hierarchical network, that is a network in which one or more IP routers have been deployed. The first device can be connected to the remote server via an access router. The remote server can in particular be connected to the access network to which the terminal connects or to another network. IP connectivity can be provided via a wired network, a wireless network (for example, 5G), or both.

No assumptions are made in the remainder as to the nature of the devices involved or the architecture of the network(s). Similarly, no assumptions are made as to the nature of the service(s) set up based on the MAC addresses.

According to at least one embodiment of the invention, the server can trigger a procedure for managing the current MAC address, by sending to the first device an instruction for managing this current MAC address. For example, such a management instruction belongs to the group comprising:
a request to renew said at least one current MAC address,
a request to extend the validity period of said at least one current MAC address.

The proposed solution thus avoids, according to at least one embodiment, communications to be traced by managing MAC addresses (for example, upon renewal of the current MAC address or upon extension of its validity period), and consequently contributes to preserving the confidentiality of the data exchanged by users of such devices or of data characteristic of these users.

Such a procedure for managing MAC addresses initiated by the server is referred to as ADET (for “ADvancEd anti-Tracking System”) procedure for example.

In particular, extending the validity period of said at least one current MAC address can be more effective in certain situations and/or for certain services, or in anticipation of a possible renewal request. This notably makes the procedure more robust (for example, by preventing the MAC addresses of all the active interfaces of a device from being renewed at the same time).

In particular, this instruction for managing the current MAC address is transmitted using a secure connection, which improves the security of the exchanges between the first device and the remote server.

For example, the first secure connection is based on a secure communication protocol, such as the QUIC, MP-QUIC (Multipath QUIC), or CoAP (Constrained Application Protocol) protocol when used in conjunction with the DTLS (Datagram Transport Layer Security) protocol, etc.

When the MP-QUIC protocol is used, connection migration can be replaced with a function for adding/removing communication paths between the server and the first device.

The proposed solution thus offers the advantage of using functions supported by a secure communication protocol.

If the secure connection implements a protocol such as QUIC, a request to renew at least one current MAC address is for example transmitted in a QUIC frame referred to herein as “MAC_RENEW”.

According to a particular embodiment, a communication being established on a first communication path between the first device and the remote server and using said at least one current MAC address, the instruction for managing said at least one current MAC address is transmitted following the detection of an event relating to said communication belonging to the group comprising:
a use period of said at least one current MAC address,
a validity period of said at least one current MAC address, or, in other words, a deadline for renewing said at least one current MAC address,
a detection of migration of the communication established on the first communication path to at least one second communication path.

According to at least one embodiment of the invention, the remote server can thus trigger the procedure for managing the current MAC address upon detection of an event relating to a communication using at least one current MAC address associated with an interface of the first device.

For example, the remote server can detect a long-term communication using said at least one current MAC address associated with at least one second interface of the first device, and ask the first device to renew the concerned current MAC address(es). In this way, the remote server can control the lifetime of a MAC address used by a client.

As a variant, the remote server can detect a migration of the communication of at least one first communication path to at least one second communication path. For example, the remote server detects a migration of the communication following the reception of a message sent by the first device with a new transport identifier (for example, a new source IP address).

The MAC address renewal request can also be transmitted to the first device prior to migration. For example, a QUIC notification can be sent by the remote server to the first device to inform it of the upcoming migration.

According to this embodiment, it is thus possible to avoid, or at least reduce, the risk that the first device is traced, particularly in case of long-term communication or connection migration.

It should be noted that such a communication can be established between the first device and the server, or the first device and a second device connected to the same network as the first device or to a separate network.

In a particular embodiment, a communication being established on a first communication path between the first device and the remote server and using said at least one current MAC address, said remote server delays the transmission of data on the first path for a defined period (for example in the order of a few milliseconds or a few seconds) or as long as the remote server has not received confirmation of the association of at least one new MAC address with said at least one second interface of said first device in order to continue the communication on the first communication path.

Said defined period can be configurable.

In other words, the remote server does not use the first communication path during the renewal of at least one MAC address associated with at least one interface of the first device, and applies a delay (referred to in the following as “pause” period) by storing the data in a buffer memory, for example. Thus, no payload is transmitted for a given period, for example, in the order of 100 ms.

In another particular embodiment, a communication being established on a first communication path between the first device and the remote server and using said at least one current MAC address, said remote server transmits data on at least one second path between the first device and the remote server for a defined period (for example, in the order of a few milliseconds or a few seconds, this period being configurable) or as long as said remote server has not received confirmation of the association of at least one new MAC address with said at least one second interface of said first device in order to continue the communication on the first communication path.

In other words, the remote server does not use the first communication path during the renewal of at least one MAC address associated with at least one interface of the first device, and transmits the data on at least one second communication path (alternative path). Thus, payload can be transmitted on another path available for a given period, for example, in the order of 1 s.

In a particular embodiment, the remote server can in particular send to the first device a request to extend the validity period of the MAC address associated with an interface of the first device used for communications with the remote server on the second path, so as to ensure that this MAC address is not modified during the defined period or as long as the remote server has not received confirmation of the association of a new MAC address with the interface of the first device and used for communications with the server on the first path.

These various embodiments prevent, or at least reduce, the risk of data loss while a MAC address is being renewed.

In a particular embodiment, the instruction for managing at least one current MAC address comprises at least one element belonging to the group comprising:
one or more interface identifiers (used to identify the interface(s) on the first device to be associated with a new MAC address),
one or more network path identifiers (used to identify the current and/or previously used communication path(s) between said first device and the remote server). For example, such identifiers can be an address, an address identifier, etc.
etc.

These identifiers, when present, can be used by the first device to select the interface(s) associated with a MAC address to be managed.

The invention also relates to a method for communication between a first device and a remote server, implemented by said first device, and comprising:
establishing a first secure connection between said first device and said remote server, via a first communication interface of said first device,
receiving, using said first secure connection, an instruction for managing at least one current MAC address associated with at least one second communication interface of said first device,
executing said management instruction.

According to this embodiment, the management of at least one MAC address of the first device is implemented at the request of the remote server.

As indicated above, the server can thus trigger a procedure for managing at least one current MAC address associated with at least one interface of the first device, for example following the detection of an event relating to a communication using this current MAC address.

In particular, the proposed solution avoids, in at least one embodiment, communications to be traced by managing MAC addresses, and consequently contributes to preserving the confidentiality of the data exchanged by users of such devices or of data characteristic of these users.

In a particular embodiment, the execution of said management instruction comprises associating at least one new MAC address with said at least one second interface.

In this way, at least one current MAC address can be renewed and replaced with a new MAC address.

In a particular embodiment, said at least one new MAC address is chosen so that it cannot be correlated with said at least one current MAC address.

In this way, a malicious device cannot detect that these MAC addresses are associated with the same device.

In particular, it is recalled that if the same MAC address associated with at least one terminal interface is exposed on different communication paths, the communications established on the different paths can be correlated.

According to this embodiment, the proposed solution thus offers a solution to contribute preserving the confidentiality of communications by avoiding exposing information that makes it possible to deduce the existence of a migration of a communication established on a first communication path to a communication established on at least one second communication path.

In a particular embodiment, the association of at least one new MAC address with said at least one second interface implements a conventional MAC address renewal technique, for example a MAC address random generation technique (randomisation).

In another embodiment, the association of at least one new MAC address with said at least one second interface implements a new technique referred to herein as MUSC (Efficient MAC address Update for Service Continuity), as described in French patent application FR2205880 filed on 16 Jun. 2022.

In particular, such a procedure can be implemented when said at least one current MAC address is used to communicate with or via at least one second device located on a communication path between said first device and said remote server, or an intermediate device located on a communication path between said first device and said second device.

In particular, such a second device can be an access router that connects said first device to the remote server. The intermediate device can be another router located on the path between the first device and the second device.

For example, the first device implements:
the establishment of a second secure connection between said first device and said second device, via a third communication interface of said first device,
the transmission, using said second secure connection, of a message comprising at least one encrypted MAC address, associated or capable of being associated with said third interface and used to communicate with or via said second device or said intermediate device.

It should be noted that the first, second and third communication interfaces of the first device can be the same interface or separate interfaces.

Thus, according to this embodiment of the invention, the first device can declare to the second device the current MAC address it uses to communicate with or via the second device, or at least one candidate MAC address it wants to use to communicate with or via the second device. Encrypting at least one MAC address increases the confidentiality of the item of information transmitted. In addition, this embodiment allows this/these MAC address(es) to be communicated to the second device when it is not directly connected to the first device (in the case of a hierarchical network, for example). Finally, it is possible for a device receiving said message to compare the source MAC address of the message (which can be carried in clear text in the message header) with the encrypted MAC address as declared in the message, in order to detect any fraudulent manipulation of MAC addresses.

The proposed solution thus contributes, according to at least one embodiment, to preserving the confidentiality of communications.

For example, the second secure connection is based on a secure communication protocol, such as the QUIC protocol, the CoAP over DTLS protocol, etc. The proposed solution thus offers the advantage of using functions supported by a secure communication protocol, rather than simply relying on the use of MAC addresses. The use of a secure channel and the encryption of MAC addresses help in particular obtain an authorisation to access the network based on the MAC address, even if the access control is activated by a device that is not on the same link (that is, located several IP hops away).

The message corresponds for example to at least one frame belonging to the group comprising:
a frame describing the current MAC address that the first device uses to communicate with or via the second device, for example a QUIC frame referred to herein as “CURRENT_MAC_ADDRESS”,
a frame describing a candidate MAC address that the first device plans to use to communicate with or via the second device, for example a QUIC frame referred to herein as “CANDIDATE_MAC_ADDRESS”,
a frame describing a list of MAC addresses that the first device plans to use to communicate with or via the second device, for example a QUIC frame referred to herein as “LIST_MAC_ADDRESS”.

In a particular embodiment, the proposed solution notably provides a continuity of service, even in case of MAC address renewal.

In particular, the proposed solution does not require any explicit authentication or the establishment of a security association between the first device (terminal, for example) and the second device (access router, for example) for each exchange of packets with devices external to the network.

In a particular embodiment, the first device and the server can exchange messages to confirm that they are capable of implementing the invention, according to at least one embodiment.

For example, the first device implements the transmission of a first parameter signalling to the server that the first device supports the MAC address management procedure initialised by the server (ADET procedure). The server also implements, for example upon receipt of this first parameter, the transmission of a second parameter signalling to the first device that the server is capable of managing the MAC addresses of the first device.

For example, such parameters are QUIC transport parameters, referred to herein as “mac-update”, and set to “1” to indicate that the device transmitting the QUIC message comprising such a parameter supports the method according to the invention.

The exchange of such parameters can be implemented before the transmission, by the server, of the MAC address management instruction.

In other embodiments, the invention relates to corresponding first device and remote server.

One embodiment of the invention also aims to protect one or more computer programs comprising instructions suitable for implementing at least one step of the methods according to at least one embodiment of the invention as described above, when this or these program(s) is/are executed by a processor, as well as at least one computer-readable data medium comprising instructions of at least one computer program as mentioned above.

### 4. LIST OF FIGURES

Other characteristics and advantages of the invention will emerge more clearly upon reading the following description of a particular embodiment, provided as a simple illustrative non-restrictive example, and the annexed drawings, wherein:

FIG. 1 shows an example of network architecture;

FIG. 2 illustrates the main steps implemented by a first device and a remote server according to at least one embodiment of the invention;

FIG. 3 illustrates the exchange of parameters to verify the compatibility of the first device and the remote device according to one embodiment of the invention;

FIG. 4 illustrates an example of network architecture implementing a MUSC procedure on one of the communication paths between the first device and the remote server;

FIG. 5 shows examples of messages exchanged between a first device, a first access router and a remote server when the MUSC procedure is implemented following the reception of a management instruction from the remote server;

FIG. 6 illustrates an example of network architecture implementing a MUSC procedure on each of the available communication paths following the reception of a management instruction from the remote server;

FIG. 7 shows examples of messages exchanged between the first device, the first access router and the remote server, and between the first device, a second access router and the remote server, when the MUSC procedure is implemented for each of the available communication paths following the reception of a management instruction from the remote server;

FIG. 8 shows the simplified structure of a first device, respectively second remote server, according to a particular embodiment.

### 5 DESCRIPTION OF AN EMBODIMENT OF THE INVENTION

### 5.1 General Principle

The general principle of the invention is based on the management, by a remote server, of at least one current MAC address associated with at least one communication interface of a first device, so as to limit the risks that the first device is traced and thus contribute to preserving the confidentiality of communications.

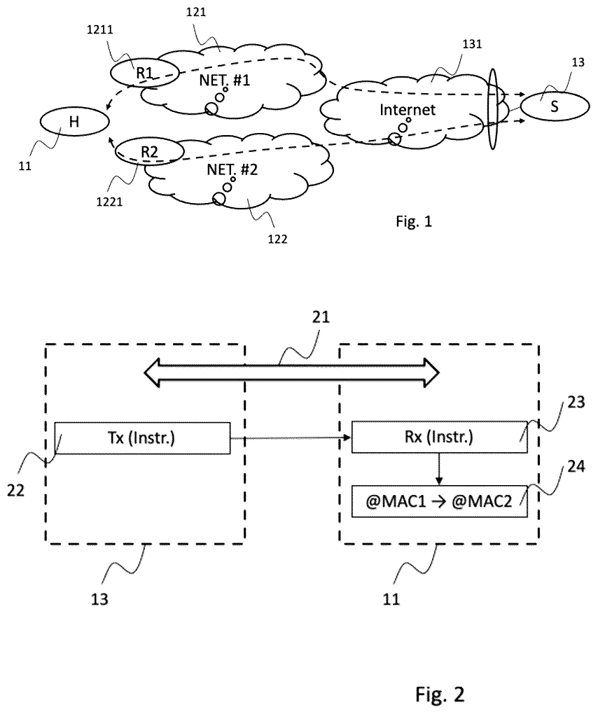

The first device and the remote server can be connected to the same network, for example to an access network, or to separate networks. For example, as shown in FIG. 1, the first device H 11 is considered to be a multi-interface terminal, that can use the same interface or separate interfaces to connect to one or more access networks.

In the following, it is considered that the first device is connected to at least one access network, for example to a first access network NET. #1 121 and a second access network NET. #2 122. The remote server S 13 can be connected to an external network, for example the network of an operator with which the user of the first device has subscribed to an Internet service offer 131 (ISP, Internet Service Provider) or to another network managed by a third party, or directly to the access networks NET. #1 121 and/or NET. #2 122. The first device 11 can communicate with the remote server 13 via the first access router R1 1211 of the first access network NET. #1 121 and/or via a second access router R2 1221 of the second access network NET. #2 122.

As previously indicated, other network architectures or other types of devices can be used in the context of the invention.

As discussed in relation to the prior art, the first device 11 classically uses the same MAC address (for example, @MAC1) to communicate with the server 13, whatever the communication path used (first communication path via the first access router 1211 or second communication path via the second access router 1221), particularly when the same interface is used to connect to these access networks. In other words, the same MAC address is exposed on the various communication paths, and the communications established on these various paths can be correlated. A malicious device can therefore easily trace communications from the first device 11, even in case the access network to which the first device connects changes.

The proposed solution makes it possible to manage at least one MAC address associated with at least one interface of the first device 11, for example by modifying this MAC address in case of migration of the communication from a first communication path to at least one second communication path. The same procedure can also be used when communication is maintained on several communication paths (that is, when the resources associated with the various paths are used simultaneously in the absence of communication migration). It is also possible to control the use period of a MAC address, for example depending on the service invoked, or to extend its validity period.

FIG. 2 illustrates the main steps implemented by a remote server and by a first device, for example the server 13 and the first device 11 of FIG. 1, to implement the methods according to at least one embodiment of the invention.

During a first step 21, a first secure connection is established between the first device and the remote server, via a first communication interface of the first device. The establishment of such a secure connection being conventional, it is not described in more detail here.

The server 13 can then transmit (22) to the first device 11, using the first secure connection, an instruction for managing at least one current MAC address associated with at least one second communication interface of the first device (the first and second communication interfaces possibly being the same interface or separate interfaces).

Such a management instruction is, for example, a request to renew the current MAC address or a request to extend the validity period of the current MAC address.

For example, the server can trigger the sending of an instruction for managing at least one MAC address when the use period of the current MAC address is greater than a defined period, when a validity period of the current MAC address is reached (corresponding to a deadline for renewing the current MAC address) and/or following the migration of a communication established on a first communication path to at least one second communication path, etc.

The first device 11 can thus receive (23) the instruction for managing at least one current MAC address associated with at least one second communication interface of the first device, using the first secure connection.

The first device can then execute (24) the corresponding management instruction, for example renewing the current MAC address @MAC1 and associating at least one new MAC address @MAC2 with the concerned interface of the first device.

According to a particular embodiment, the first device can implement a conventional procedure for associating at least one MAC address with at least one of its interfaces.

In another embodiment, the first equipment can implement a new procedure for associating at least one MAC address with at least one of its interfaces, referred to as MUSC procedure, as described in the above-mentioned French patent application FR2205880.

Such a MUSC procedure can in particular be implemented between the first device and a second device located on a communication path between the first device and the server, for example the first access router 1211 and/or the second access router 1221 of FIG. 1.

### 5.2 Embodiments

Various embodiments of the invention are described below, according to which the first secure connection between the server and the first device uses the QUIC protocol. As already indicated, in other embodiments, the first secure connection can use the CoAP over DTLS protocol or any other protocol establishing a secure connection. No assumptions are made about the use of the QUIC protocol. The proposed solution can also be applied to QUIC communications established on several paths by using the MP-QUIC resources. The use of all or part of these various paths can be negotiated between the server and the first device.

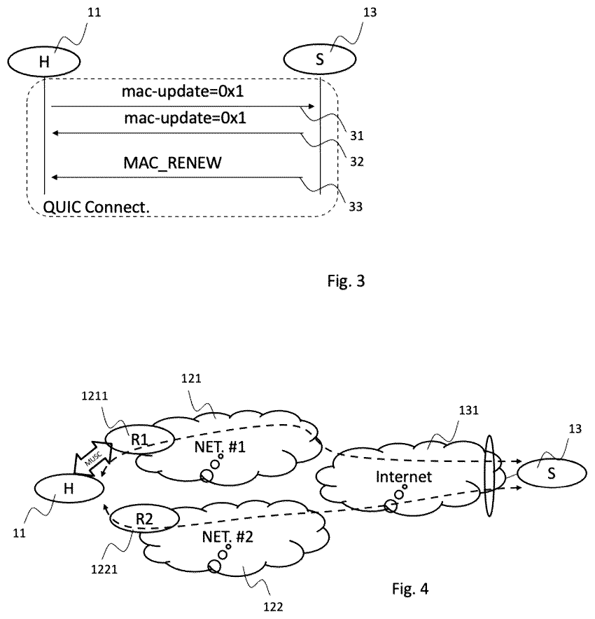

As illustrated in FIG. 3, according to a particular embodiment, the first device can use a new QUIC transport parameter (as provided for in section 7.4.2 of document RFC 9000, May 2021), referred to herein as “mac-update”, to signal to the server that it supports the MAC address management procedure initialised by the server (ADET procedure). For example, the first device 11 implements the transmission 31 of a first parameter signalling to the server 13 that the first device 11 is capable of modifying its current MAC address or extending its validity period, using the first secure connection. If the server also supports the ADET procedure, it can respond using the new “mac-update” QUIC transport parameter, also using the first secure connection. In other words, the server 13 implements the transmission 32 of a second parameter signalling to the first device 11 that the server 13 is capable of managing at least one MAC address associated with at least one interface of the first device.

These first and second parameters are for example set to “1” (mac-update=0×1) to indicate that the ADET procedure is supported.

The server can then transmit to the first device a MAC address management instruction, for example a request to renew at least one of its current MAC addresses in a QUIC frame referred to herein as “MAC_RENEW” 33.

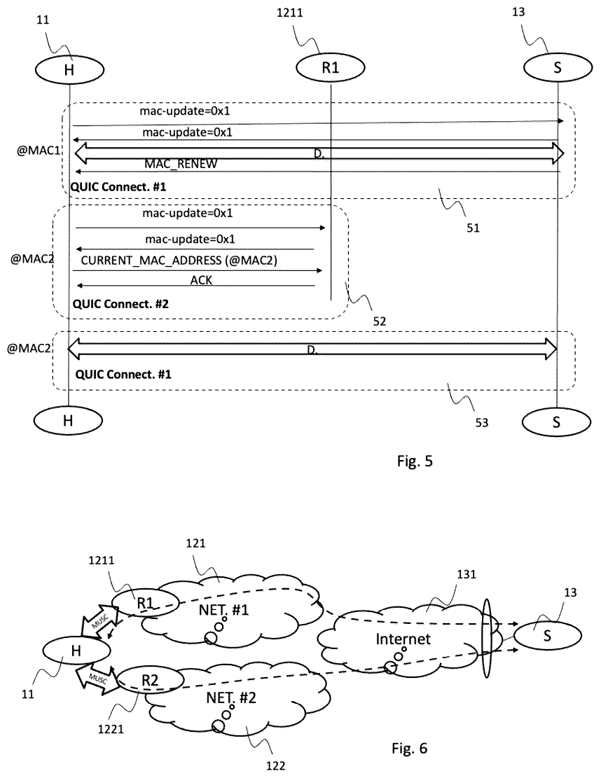

One embodiment of the invention is presented below in relation to FIGS. 4 and 5.

FIG. 4 illustrates an example of a network architecture according to which the first device 11 can communicate with the remote server 13 via the first access router R1 1211 of the first access network NET. #1 121.

FIG. 5 illustrates examples of messages exchanged between the first device 11, the first access router 1211 and the remote server 13 when the MUSC procedure is implemented following the reception of a management instruction from the remote server;

A QUIC Connect. #1 secure connection (51) is established between the first device 11 and the server 13. The QUIC Connect. #1 secure connection established between the first device 11 and the server 13 via the first access router 1211 is characterised by connection identifiers CID (in particular source CID).

As explained in relation to FIG. 3, “mac-update” QUIC transport parameters can be exchanged between the first device 11 and the server 13 to verify that they support the MAC address management procedure (ADET procedure) according to one embodiment of the invention.

It is assumed in the following that the first device 11 and the server 13 support the ADET procedure.

Data D can in particular be exchanged between the first device 11 and the server 13 via the QUIC Connect. #1 secure connection, by the first communication path via the first access router 1211.

For example, it is considered that the server 13 detects that the first device 11 has established a long-term communication (for example, longer than a given threshold recommended for the current service) with a second device located on the first communication path (for example, with the server 13 or with the first access router 1211), using a current MAC address @MAC1 associated with a communication interface of the first device to communicate with or via the second device.

The server 13 can then trigger the MAC address management procedure so as to prevent the first device from lastingly establishing communications based on the use of the same MAC address.

To do this, the server 13 can send a request to renew the @MAC1 address used by the first device 11, so that the MAC address used to transmit packet on the first path is modified. The server 13 can, for example, send a MAC_RENEW frame to the first device 11 via the QUIC Connect. #1 secure connection, and a MAC address negotiation cycle can then be triggered.

In particular, a MUSC procedure can be implemented between the first device 11 and the second device, to associate a new MAC address with the interface used by the first device to communicate with or via the second device. For example, the second device is considered to be the first access router 1211.

To do this, a QUIC Connect. #2 secure connection (52) is established between the first device 11 and the first access router 1211. For example, such a secure connection uses the QUIC protocol, the CoAP over DTLS protocol, etc.

The first device 11 can then transmit a message to the first access router 1211, using the QUIC Connect. #2 secure connection. Such a message comprises at least one encrypted MAC address, associated or capable of being associated with the considered interface of the first device and used to communicate with or via the first access router 1211 or an intermediate device located on a communication path between the first device and the first access router 1211.

The first access router 1211 can thus receive such a message and validate the received MAC address(es).

Various types of messages can be sent from the first device 11 to the first access router 1211.

In the example of FIG. 4, the first device 11 can generate at least one new MAC address @MAC2 and transmit this new address @MAC2 encrypted in a message using the QUIC Connect. #2 secure connection. The first access router 1211 can then validate the new address @MAC2 and, if applicable, update the filtering rules it maintains.

For example, once the new address @MAC2 is associated with the considered interface of the first device, the new address @MAC2 becomes the current MAC address associated with the considered interface. A message corresponding to at least one QUIC frame describing the current MAC address that the first device uses to communicate with or via the first access router 1211, referred to herein for example as “CURRENT_MAC_ADDRESS”, can then be transmitted from the first device 11 to the first access router 1211.

The insertion of the current MAC address in the new frame, and therefore its encryption related to the use of the QUIC secure connection, enables the first access router 1211 to compare information carried in the encrypted part of the message (for example, the current MAC address) with information conveyed in clear text in the QUIC connection (for example, the source MAC address) and to detect any manipulation of the information conveyed in clear text. Inserting the current MAC address in the new frame also allows the current MAC address to be communicated to the first access router 1211 even if it is not directly connected to the first device (in the case of an intermediate device such as a router, for example).

The first device 11 can then use the address @MAC2 to communicate with the server 13 using the first QUIC Connect. #1 secure connection (53), via the first access router 1211.

It should be noted that prior to transmission of the encrypted message over the QUIC Connect. #2 secure connection, “mac-update” QUIC transport parameters can be exchanged between the first device 11 and the first access router 1211 to verify that they support the MUSC procedure according to one embodiment of the invention.

For example, the first device uses the new “mac-update” QUIC transport parameter to signal to the first access router 1211 that it supports the MUSC procedure. If the first access router 1211 also supports the MUSC procedure, it can respond using the new “mac-update” QUIC transport parameter.

These first and second parameters are for example set to “1” (mac-update=0×1) to indicate that the MUSC procedure is supported.

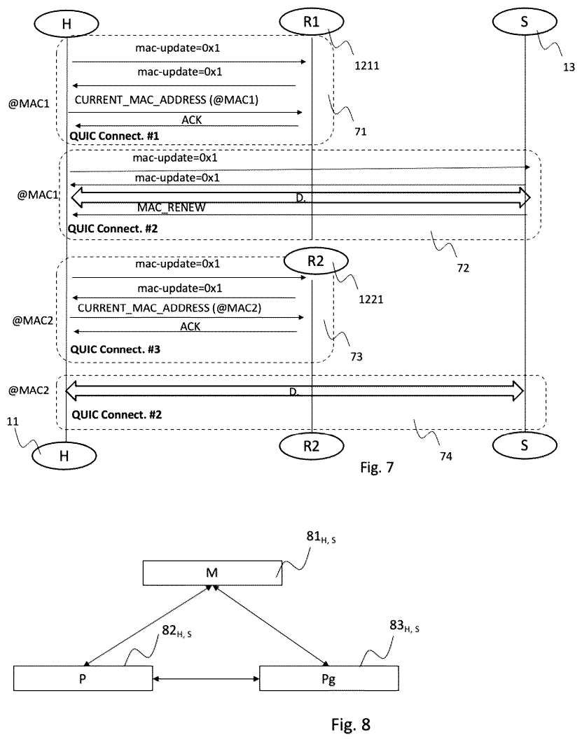

In relation to FIGS. 6 and 7, another example embodiment of the invention, according to which the MUSC procedure can be implemented before the ADET procedure, is now presented. Indeed, no assumptions are made as to the order in which these various steps of the invention are invoked.

FIG. 6 illustrates an example of a network architecture according to which the first device 11 can communicate with the remote server 13 via the first access router R1 1211 of the first access network NET. #1 121 and/or via the second access router R2 1221 of the second access network NET. #2 122.

FIG. 7 illustrates examples of messages exchanged between the first device 11, the first access router 1211 and the server 13, and between the first device 11, the second access router 1221 and the server 13, when the MUSC procedure is implemented for each of the available communication paths between the first device and the remote server following the reception of a management instruction from the remote server;

According to this second example, a MUSC procedure can be implemented between the first device 11 and a second device located on a communication path between the first device 11 and the server 13. For example, a first MUSC procedure can be implemented between the first device 11 and the first access router 1211, and a second MUSC procedure can be implemented between the first device 11 and the second access router 1221. As many MUSC procedures as there are communication paths between the first device 11 and the server 13 can be implemented.

The first MUSC procedure implements the following steps.

A QUIC Connect. #1 secure connection (71) is established between the first device 11 and the first access router 1211. For example, such a secure connection uses the QUIC protocol, or as a variant the CoAP over DTLS protocol, etc.

As explained above, the “mac-update” QUIC transport parameters can possibly be exchanged between the first device 11 and the first access router 1211 to verify that they support the MUSC procedure according to one embodiment of the invention.

The first device 11 can then transmit a message to the first access router 1211, using the QUIC Connect. #1 secure connection. As indicated above in relation to FIG. 5, such a message comprises at least one encrypted MAC address, associated or capable of being associated with the considered interface of the first device and used to communicate with or via the first access router 1211 or an intermediate device located on a communication path between the first device and the first access router 1211.

The first access router 1211 can thus receive such a message and validate the received MAC address(es).

Various types of messages can be sent from the first device 11 to the first access router 1211.

According to a first example, the message corresponds to a “CURRENT_MAC_ADDRESS” QUIC frame describing the current MAC address that the first device uses to communicate with or via the first router access 121. Such a current MAC address is therefore already assigned to the interface used to contact the first access router 1211.

According to a second example, the first device 11 can prepare the MAC address migration by first indicating to the first access router 1211 at least one MAC address it plans to use, referred to as candidate MAC address.

According to this second example, the message sent from the first device 11 to the first access router 1211, via the first QUIC Connect. #1 secure connection, corresponds to a QUIC frame, referred to herein as “LIST_MAC_ADDRESSES” for example, comprising at least one encrypted candidate MAC address that the first device plans to use to communicate with or via the first access router 1211 (for example, a5:c7:ef:82:58:e9, e1:44:5c:32:3c:72, ee:3c:50:18:7e:44). At this stage, none of these candidate MAC addresses is associated with the considered interface of the first device 11.

In particular, before associating a candidate MAC address with an interface of the first device 11, the first device 11 can verify with the first access router 1211 that the candidate MAC address is available. In particular, this makes it possible to avoid a conflict with the MAC addresses used by other devices connected to the same network and avoids impacting the service access time due to a MAC address change.

According to a third example, the message sent by the first device 11 to the first access router 1211, via the QUIC Connect. #1 secure connection, corresponds to a QUIC frame, referred to herein as “CANDIDATE_MAC_ADDRESS” for example, comprising at least one encrypted candidate address.

Thus, according to these various examples, the first device implements a MUSC procedure to associate a MAC address with at least one of its interfaces and to validate this MAC address.

As a variant, the first device can use a default MAC address, configured for example by a user of the first device or by the operating system.

In the example illustrated in FIG. 7, it is considered for example that the first device 11 transmits to the first access router 1211 a message corresponding to a “CURRENT_MAC_ADDRESS” QUIC frame having the address @MAC1.

A QUIC Connect. #2 secure connection (72) is also established between the first device 11 and the server 13 (before, during or after the QUIC Connect. #1 secure connection is established). Several connection identifiers can be used.

For example, the QUIC Connect. #2 secure connection established between the first device 11 and the server 13 via the first access router 1211 (resp. second access router 1221) is characterised by first (resp. second) connection identifiers, in particular source CID, negotiated beforehand (Section 19.15 of RFC 9000) with the server 13. It is therefore considered that only one single secure connection exists between the first device 11 and the server 13, corresponding to the various communication paths between the first device 11 and the server 13.

As explained in relation to FIG. 3, “mac-update” QUIC transport parameters can be exchanged between the first device 11 and the server 13 to verify that they support the MAC address management procedure (ADET) according to one embodiment of the invention.

Data D can in particular be exchanged between the first device 11 and the server 13 via the QUIC Connect. #2 secure connection, by the first communication path via the first access router 1211.

If the first device 11 is mobile for example, or if the traffic via the first access router 1211 is congested, the first device 11 can migrate a communication established with the server 13 on the first path via the first access router 1211 to a second path via the second access router 1221.

It is considered for example that the server 13 detects the use of a new transport identifier (for example, a new source IP address when the data packets from the first device 11 and destined for the server 13 arrive via at least one new path or during a connection migration attempt). For example, the server 13 detects that it is receiving data packets from various source addresses.

The server 13 can trigger the MAC address management procedure according to one embodiment of the invention, so as to prevent the first device from still using the current MAC address @MAC1 to communicate with or via the second access router 1221.

To do this, the server 13 can send a request to renew the address @MAC1 used by the first device 11, so that the MAC address used to transmit packets via the second path is different from the one used to transmit data on the first path. The server 13 can, for example, send a MAC_RENEW frame to the first device 11 via the QUIC Connect. #2 secure connection, and a MAC address negotiation cycle can be triggered. It is recalled that the order of the various QUIC Connect. #1 (71) and QUIC Connect. #2 (72) secure connections does not matter.

In particular, a MUSC procedure can be implemented between the first device 11 and the second router access 1221, to associate a new MAC address with the interface used by the first device to communicate with or via the second router access 1221.

To do this, a QUIC Connect. #3 secure connection (73) is established between the first device 11 and the second access router 1221. For example, such a secure connection uses the QUIC protocol, or as a variant the CoAP over DTLS protocol, etc.

In the example of FIG. 7, the first device 11 can generate at least one new MAC address @MAC2 and transmit this new address @MAC2 encrypted in a CURRENT_MAC_ADDRESS message using the QUIC Connect. #3 secure connection. The second access router 1221 can then validate the new address @MAC2 and, if applicable, update the filtering rules it maintains.

The first device 11 can then use the address @MAC2 to communicate with the server 13 using the QUIC Connect. #2 secure connection (74), via the second access router 1221. A new connection identifier can be used during migration. This identifier can be exchanged beforehand according to the procedure described in Section 19.15 of RFC 9000.

The QUIC Connect. #2 secure connection is therefore established on both paths via the first access router 1211 and via the second access router 1221, and either or both of the paths can be used to exchange data between the first device 11 and the server 13.

In a particular embodiment, the remote server can, as a variant or additionally, send a request to extend the validity period of at least one current MAC address, for example the address @MAC1 used for communications on the first path. The address @MAC1 can thus be retained for communications via the first access router 1211, and the address @MAC2 can be used for communications via the second access router 1221. It should be noted that the MAC addresses used on the alternative paths are not communicated to the access routers located on the other paths.

The proposed solution can thus negotiate different MAC addresses for the first device 11, according to the access network to which it is attached, even though the same interface of the first device 11 would be used for communications with the various access networks. For example, the first device 11 can communicate with the first access router 1211 via a first interface of the first device 11 using the MAC address @MAC1, and the first device 11 can communicate with the second access router 1221 via the first interface of the first device 11 using the MAC address @MAC2.

In these various embodiments, the new MAC address(es) is/are chosen so that it/they cannot be correlated with the current MAC address(es), in order to prevent the first device from being traced. Thus, the first device uses a new MAC address that cannot be correlated with a MAC address used previously, for example in the last 24 hours.

According to at least one embodiment, the first device 11 can in particular confirm its MAC address renewal, by transmitting a message via the secure connection established with the server 13 (QUIC Connect. #1 according to FIG. 5 or QUIC Connect. #2 according to FIG. 7).

For example, such a message transmitted from the first device to the server is referred herein as “MAC_RENEWED” and comprises the new MAC address associated with the considered interface of the first device 11.

According to at least one embodiment, a communication using the current MAC address @MAC1 being established on the first communication path via the first access router 1211, the remote server 13 delays the transmission of data on the first path for a defined period or as long as the remote server has not received confirmation of the association of at least one new MAC address with the first device in order to continue the communication on the first path (for example, as long as the remote server has not received a MAC_RENEWED message).

In other words, the server 13 can apply a “pause” period during the renewal of the MAC address of the first device 11 and associated with the first path, in order to avoid, or at least reduce, the risk of packet loss while the MAC address is being modified by the first device 11 according to the indications received from the server 13. For example, the server 13 does not send any payload on the first path for a short configurable period, for example in the order of 100 ms.

According to at least one embodiment, a communication using the current MAC address @MAC1 being established on the first communication path via the first access router 1211, the remote server 13 transmits data on at least one other path for a defined period or as long as the remote server has not received confirmation of the association of at least one new MAC address with the first device in order to continue the communication on the first path (for example, as long as the remote server has not received a MAC_RENEWED message).

In other words, the server 13 can use another path during the renewal of the MAC address of the first device 11 associated with the first path, in order to avoid, or at least reduce, the risk of packet loss while the MAC address is being modified by the first device 11 according to the indications received from the server 13. For example, the server 13 sends the payload on at least one other available path (for example, the second path via the second access router) for a short configurable period, for example in the order of 1 s. It can also send the data in duplicate via the first path and via at least one other available path, so as to ensure that the first device receives the payload.

According to a particular embodiment, the server can send a request to extend the validity period of the MAC address @MAC2 used for communications on the second path while the MAC address @MAC1 used for communications on the first path is being renewed.

According to at least one embodiment, the first device can refuse the implementation of the ADET procedure, in particular if a similar management instruction has already been received (for example, the same instruction has been received several times, a similar management instruction has been received from another server, etc.) or conflicts with a previously received management instruction. To do this, a new error message can be transmitted by the first device to the server, for example using a new QUIC frame referred to herein as “REJECT_MAC_RENEW”.

In the embodiments presented above, the server 13 initiates the renewal of at least one MAC address of the first device. Therefore, the server sends a “MAC_RENEW” QUIC frame to the first device. It is considered however that the first device cannot send a “MAC_RENEW” QUIC frame to the server. In other words, the first device does not initiate the renewal of at least one MAC address associated with one of its interfaces. If a “MAC_RENEW” message is received by the server, the server can ignore it.

The implementation of a MUSC procedure for associating MAC addresses on the interfaces of the first device for all paths available between the first device and the server has been described above in relation to FIGS. 6 and 7. As a variant, such a procedure can be implemented on certain paths only. As a variant, such a procedure can be implemented upon receipt of a MAC address renewal request sent by the remote server (reception of a MAC_RENEW QUIC frame by the first device).

According to one embodiment, a new MAC address can be generated in the conventional way for at least one interface of the first device or one path. In this case, the first device implements locally a procedure for generating MAC addresses that cannot be correlated with the MAC addresses used in the past (for example, in the last 24 hours).

In a particular embodiment, the MAC address random generation is implemented locally by the first device. In particular, the server can ask the first device to extend the validity of at least one MAC address associated with at least one of its interfaces (which may be the one for which the address renewal is performed or another interface, particularly in the case of short-term communication).

### 5.3 Corresponding Devices

Finally, in relation to FIG. 8, the simplified structures of a first device H and a server S according to at least one embodiment of the invention are presented.

A first device H (resp. the server S) according to one embodiment of the invention comprises a memory 81_{H} (resp. 81_{S}), a processing unit 82_{H} (resp. 82_{S}), equipped for example with a programmable computing machine or a dedicated computing machine, for example a processor P, and controlled by the computer program 83_{H} (resp. 83_{S}), implementing steps of the communication method (resp. communication management method) according to at least one embodiment of the invention.

At initialisation, the code instructions of the computer program 83_{H} (resp. 83_{S}) are for example loaded into a RAM memory before being executed by the processor of the processing unit 82_{H} (resp. 82_{S}).

The processor of the processing unit 82_{H} of the first device implements steps of the communication method previously described, according to the instructions of the computer program 83_{H}, to:
establish a first secure connection between a first device and said remote server, via a first communication interface of said first device,
transmit, using said first secure connection, an instruction for managing at least one current MAC address associated with at least one second communication interface of the first device.

The processor of the processing unit 82S of the server implements steps of the communication management method previously described, according to the instructions of the computer program 83S, to:
establish a first secure connection between said first device and a remote server, via a first communication interface of said first device,
receive, using said first secure connection, an instruction for managing at least one current MAC address associated with at least one second communication interface of said first device,
execute said management instruction.

1. A method for managing communications of a first device, implemented by a remote server, comprising:
establishing a first secure connection between said first device and said remote server, via a first communication interface of said first device, said first device and said remote server being connected to separate networks; and
transmitting, using said first secure connection, an instruction for managing at least one current Media Access Control (MAC) address associated with at least one second communication interface of the first device, said instruction being transmitted for execution of the management instruction by the first device.

2. The method according to claim 1, wherein a communication being established on a first communication path between said first device and said remote server and using said at least one current MAC address, said instruction for managing at least one current MAC address is transmitted following detection of an event relating to said communication, the event corresponding to:
a use period of said at least one current MAC address,
a validity period of said at least one current MAC address, or
a detection of migration of said communication established on said first communication path to at least one second communication path.

3. The method according to claim 1, wherein a communication being established on a first communication path between said first device and said remote server and using said at least one current MAC address, said remote server delays transmission of data on said first path for a defined period or as long as the remote server has not received confirmation of an association of at least one new MAC address with said at least one second interface of said first device in order to continue said communication on said first communication path.

4. The method according to claim 1, wherein a communication being established on a first communication path between said first device and said remote server and using said at least one current MAC address, said remote server transmits data on at least one second communication path between said first device and said remote server for a defined period or as long as said remote server has not received confirmation of an association of at least one new MAC address with said at least one second interface of said first device in order to continue said communication on said first communication path.

5. The method according to 1, wherein said instruction for managing at least one current MAC address comprises at least one element among:
at least one identifier for identifying said at least one second communication interface, or
at least one identifier of a communication path for identifying at least one current and/or previously used communication path between said first device and said remote server.

6. A method for communication between a first device and a remote server, implemented by said first device, comprising:
establishing a first secure connection between said first device and said remote server, via a first communication interface of said first device, said first device and said remote server being connected to separate networks;
receiving, using said first secure connection, an instruction for managing at least one current Media Access Control (MAC) address associated with at least one second communication interface of said first device; and
executing said management instruction.

7. The method according to claim 6, wherein the execution of said management instruction implements an association of at least one new MAC address with said at least one second interface.

8. The method according to claim 7, wherein said at least one new MAC address is chosen so that said at least one new MAC address cannot be correlated with said at least one current MAC address.

9. The method according to claim 6, wherein said at least one current MAC address is used to communicate with or via at least one second device located on a communication path between said first device and said remote server, or an intermediate device located on a communication path between said first device and said second device.

10. The method according to claim 9, wherein the method comprises:
establishing a second secure connection between said first device and said second device, via a third communication interface of said first device,
transmitting, using said second secure connection, a message comprising at least one encrypted MAC address, associated or capable of being associated with said third interface and used to communicate with or via said second device or said intermediate device.

11. The method according to claim 1, wherein said first and/or second secure connections implement the QUIC protocol.

12. The method according to claim 1, wherein said instruction for managing at least one current MAC address corresponds to:
a request to renew said at least one current MAC address, or
a request to extend a validity period of said at least one current MAC address.

13. A remote server comprising at least one processor configured to:
establish a first secure connection between a first device and said remote server, via a first communication interface of said first device, said first device and said remote server being connected to separate networks; and
transmit, using said first secure connection, an instruction for managing at least one current MAC address associated with at least one second communication interface of the first device, for execution of the management instruction by the first device.

14. A first device comprising at least one processor configured to:
establish a first secure connection between said first device and a remote server, via a first communication interface of said first device, said first device and said remote server being connected to separate networks; and
receive, using said first secure connection, an instruction for managing at least one current MAC address associated with at least one second communication interface of said first device,
execute said management instruction.

15. A non-transitory computer readable medium comprising a computer program stored thereon comprising instructions which, when these instructions are executed by a processor, cause the processor to implement the method according to claim 1.

16. A non-transitory computer readable medium comprising a computer program stored thereon comprising instructions which, when these instructions are executed by a processor, cause the processor to implement the method according to claim 6.

17. The method according to claim 6, wherein said first and/or second secure connections implement the QUIC protocol.

18. The method according to claim 6, wherein said instruction for managing at least one current MAC address corresponds to:
a request to renew said at least one current MAC address, or
a request to extend a validity period of said at least one current MAC address.
